(19) United States
(12) Patent Application Publication
(10) Pub. No.: US 2015/0247042 A1
(43) Pub. Date: Sep. 3, 2015

(54) Antifouling Paint Formulation Incorporating Tungsten Nanotubes

(71) Applicant: Roc Hatfield, Safety Harbor, FL (US)

(72) Inventor: Roc Hatfield, Safety Harbor, FL (US)

(73) Assignee: N1 Technologies, Daytona Beach, FL (US)

(21) Appl. No.: 14/712,316

(22) Filed: May 14, 2015

Related U.S. Application Data
(60) Provisional application No. 62/048,633, filed on Sep. 10, 2014.

(51) Int. Cl. C09D 5/16

(52) U.S. Cl. CPC C09D 5/1687; C08K 3/30

(57) ABSTRACT

An antifouling paint formulation incorporating tungsten nanotubes is applied to surfaces to impart a biomimetic antifouling coating, as well as, repairing and strengthening microscopic fractures of the surface. The antifouling paint formulation includes a paint base, a tungsten sulfide nanotube filler, and a quantity of biocides. The quantity of biocides inhibit and prevent the growth of organisms on the painted surface. The tungsten nanotube filler fills the void within microscopic fractures, reinforcing the surface material. The paint base includes a color pigment, a bonding resin within a volatile solvent. The quantity of biocides and the tungsten sulfide nanotube filler are mixed into the paint base in order to be dispersed across the surface as the antifouling paint formulation is painted on the surface.

The current application claims a priority to the U.S. Provisional Patent application Ser. No. 62/048,633 filed on Sep. 10, 2014.

### FIELD OF THE INVENTION

The present invention relates generally to environmentally-friendly antifouling technology paint. More specifically, the present invention is an antifouling paint that utilizes biocides resulting in no bio-accumulation in the environment while strengthening the painted surface material through the use of a nanotube filler.

### BACKGROUND OF THE INVENTION

Traditional antifouling paints are applied to the hull of a ship or boat to slow the growth of organisms that attach to the hull. These antifouling paints are typically formulated with toxic copper, organotin compounds, or other biocides. Because these components paints are considered to be pesticides and environmentally hazardous, the substance is critically examined over environmental groups and departments. For the past half-century, port regulation organizations have investigated ways to reduce the copper input from antifouling coatings due to some evidence of significant environmental danger.

Although antifouling paints do pose some risks, there are multiple advantages towards applying antifouling paints to ships and boats. As previously mentioned, the antifouling paint slows the growth of organisms such as barnacles, algae and other marine organisms on the submerged underside of ships. Not only do antifouling paints slow the growth of organisms that can attach to the hull, but antifouling paints also enhance the performance and durability of the marine vessel. The present invention employs the advantages that traditional antifouling paints have without the environmental damages that metals like copper do to the environment.

The present invention is an antifouling paint that utilizes metal-free and copper-free biocides resulting in no bio-accumulation in the environment. Through the inclusion of biocides, the present invention creates and antifouling coating on the surface the present invention has been painted in order to prevent and slow the growth of organisms. The application of the present invention further reduces the impact of small environmental fractures improving the hydrodynamics of the hulls of ships.

### BRIEF DESCRIPTION OF THE DRAWINGS

FIG. 1 illustrates the ingredients of the present invention.

FIG. 2 exemplifies the application of the tungsten nanotubes dispersed across a microscopic fractured surface.

FIG. 3 illustrates the cylindrical lattice structure for each of the plurality of tungsten sulfide nanotubes.

FIG. 4 illustrates a tungsten nanotube being concentrically positioned within another tungsten nanotube.

### DETAIL DESCRIPTIONS OF THE INVENTION

All illustrations of the drawings are for the purpose of describing selected versions of the present invention and are not intended to limit the scope of the present invention.

The present invention is an antifouling paint formulation incorporating tungsten nanotubes. The present invention is preferred to be applied to the exterior of a ship's hull to deter the growth of organisms on the hull as well as repair minor damage to the hull. Through exposure to sea water, organisms, such as barnacles and algae, attach and grow on the underside of ships. Such growths impact the hydrodynamics of the ship, lowering the efficiency of travel through bodies of water. Similarly, travel through bodies of water results in small damages and fractures to the hull from abrasion of debris floating in and the bed of bodies of water. An object of the present invention is to prevent the loss of hydraulic traveling efficiency from bioaccumulation as well as imperfections and fractures within a ship's hull material.

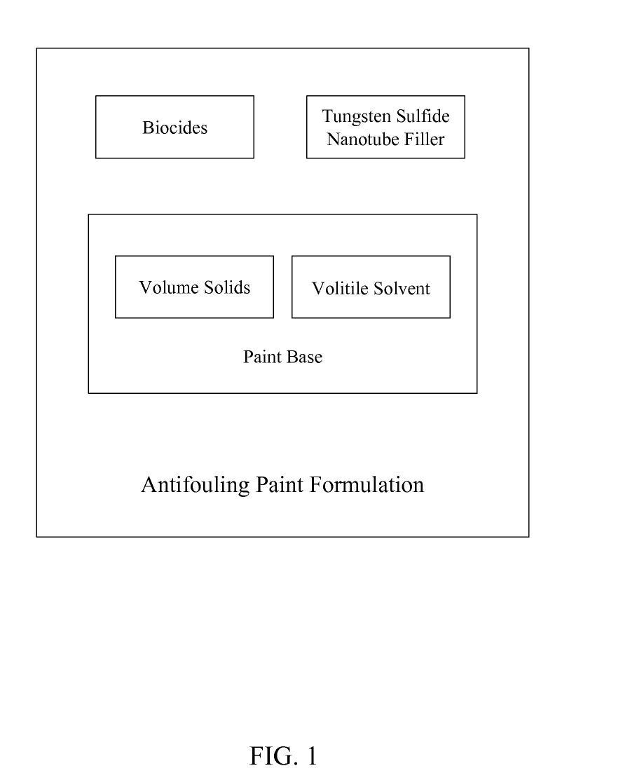

In accordance to FIG. 1, the present invention comprises a paint base, a tungsten sulfide nanotube filler, and a quantity of biocides. The paint base provides a fluid medium for the tungsten sulfide nanotube filler and the quantity of biocides to be suspended with and imparted onto a surface desired to be painted. The tungsten sulfide nanotube filler reinforces microscopic fractures on a surface which the present invention is painted. The quantity of biocides are included to form a biomimetic antifouling coating. The paint base comprises volumetric solids and a volatile solvent. The volumetric solids bond to the painted surface when the volatile solvent evaporates. The volumetric solids include, but are not limited to, color pigments and bonding resins to impart a color hue and secure the color onto the surface. The volatile solvent imparts fluid properties to the paint base; however, the volatile solvent evaporates easily as the bonding resin solidifies onto the painted surface. The quantity of biocides and the volume solids are homogeneously amalgamated into the volatile solvent. The tungsten sulfide nanotube filler is heterogeneously suspended throughout the paint base. The quantity of biocides and the tungsten sulfide nanotube filler are mixed within the paint base such that the quantity of biocides and the tungsten sulfide nanotube filler are dispersed across the painted surface.

In accordance to the preferred embodiment, the quantity of biocides is approximately 4.5% by weight (wt.), the tungsten sulfide nanotube filler is approximately 6% wt., and the volume solids are between 60% and 64% wt. of the paint formulation. More specifically, the volume solids are preferred to be approximately 62% wt. of the paint formulation.

TABLE 1

| | Approximate Composition |
|---|---|
| Ingredient | by Weight |
| Biocides | 4.5% |
| Tungsten Nanotube Filler | 6.0% |
| Volume Solids | 60-64% |

The remaining percentage includes the volatile solvent and other inert components. This preferred composition for the paint formulation allows for a sufficient quantity of biocides to prevent and reduce attachment and growth of organisms on the painted surface; as well as, sufficient tungsten sulfide nanotube filler to allow for reinforcement to microscopic fractures of the painted material. The preferred quantity of volume solids allows for sufficient pigment to be imparted to the surface of the painted material as the present invention dries on the surface as well as binding the pigment, the quantity of biocides and the tungsten sulfide nanotube filler to the surface within the resin.

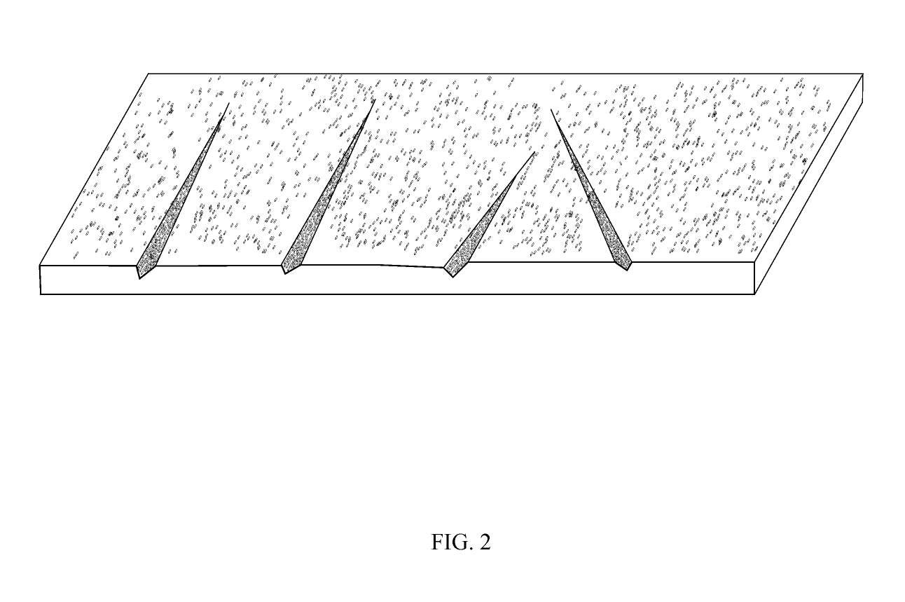

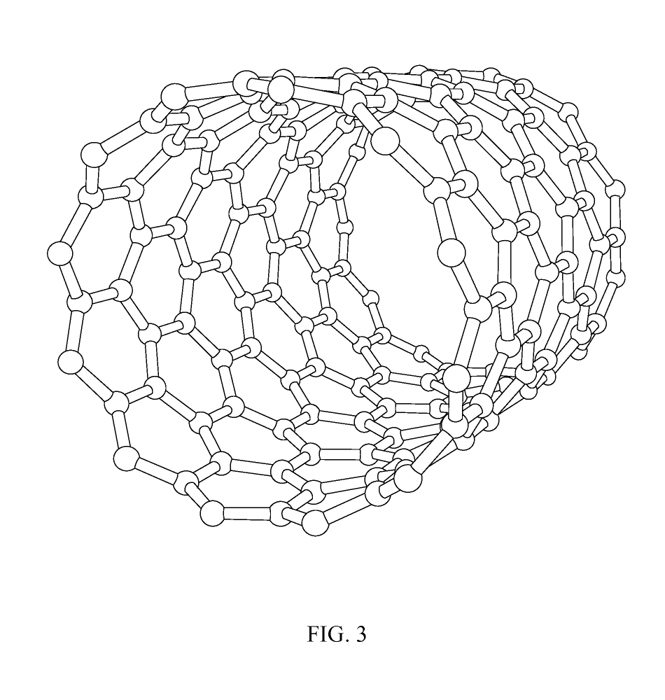

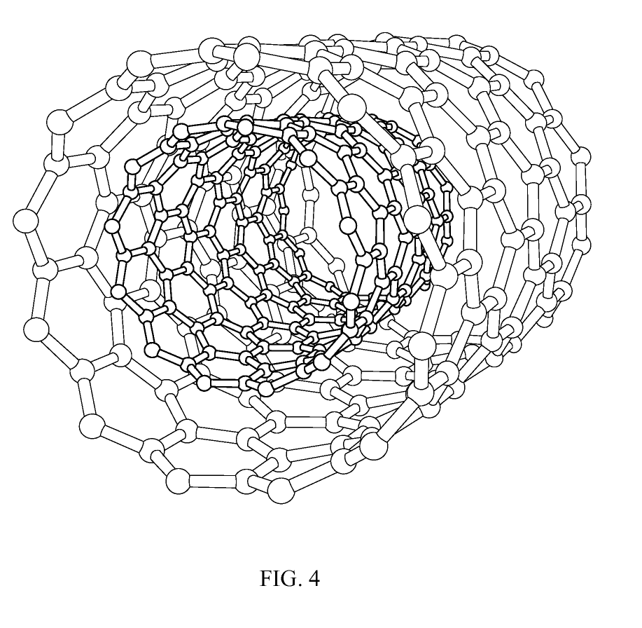

Further in accordance to the preferred embodiment the tungsten sulfide nanotube filler is a plurality of tungsten sulfide nanotubes. The plurality of tungsten nanotubes is shown dispersed across as surface filling microscopic fractures of the surface when the present invention is painted onto a surface, as shown in FIG. 2. To assist in the reinforcement of microscopic fractures, each of the plurality of tungsten sulfide nanotube filler is configured as a cylindrical lattice structure, as illustrated in FIG. 3. The cylindrical lattice structure allows for more elastic deformation as pressure is applied laterally to each of the plurality of tungsten sulfide nanotubes. In accordance to FIG. 4, a fraction of the plurality of tungsten sulfide nanotubes is concentrically positioned within each other to further facilitate the elastic deformation reinforcing the external tungsten sulfide nanotube.

As previously mentioned, the quantity of biocides forms a biomimetic antifouling coat to deter organic attachment and growth on the painted surface. The quantity of biocides is preferred to be a non-metal compound, including but not limited to terpenes, and non-terpenes found in extracts of sponges, algae, corals, sea urchins and other various marine life. Such natural and non-metallic synthesized biocides are preferred to limit the environmental impact of biocides on bodies of water.

To insure the present invention adheres properly, the surface intended to be painted needs to be cleaned properly. With an existing antifouling coating, the surface to be painted is initially pressure washed in order to remove loose paint, grease, and surface contaminants. Subsequently, this surface is scuffed to allow the paint to better adhere to this surface. Residue from scuffing is removed, and this surface is left to dry. The surface is then coated with the present invention. Several hours are needed between subsequent coats of the present invention to allow previous coats to cure before another coat of the present invention is applied.

In scenarios where the surface has an existing antifouling coating of unknown compatibility, a primer is applied to the surface to be painted after the surface has been scuffed. Subsequently, the present invention is applied once the primer has dried. Several hours are needed between subsequent coats of the present invention to allow previous coats to cure before another coat of the present invention is applied. When the exiting antifouling coating is in exceptionally poor conditions, the previously cracked, flaking, or peeling coats are stripped from the surface by a chemical means or by sand blasting the surface before the primer is applied.

For application to aluminum surfaces, instead of pressure washing, the surface is sandblasted clean and the blasting residue is removed using a brush or compressed air. A primer is then applied and allowed to dry until the primer becomes tacky. Tacky refers to a point in the drying process where the user is able to press their thumb into the primer film where a thumbprint is imprinted into the film without imparting a portion of the film onto the user's thumb. Once the primer has become tacky, the coats of the present invention are applied where sufficient time elapses between coats to allow for drying.

When applying the present invention to bare fiberglass or gel coat for the first time, all surface contaminants need to be removed from the surface. The surface is cleaned and de-waxed using soap and a dewaxing solvent, respectively. The surface is sealed by applying a primer. Once the primer becomes tacky, the present invention is applied to the surface.

Although the invention has been explained in relation to its preferred embodiment, it is to be understood that many other possible modifications and variations can be made without departing from the spirit and scope of the invention as hereinafter claimed.

What is claimed is:

1. An antifouling paint formulation incorporating tungsten nanotubes comprises:
a paint base;
a tungsten sulfide nanotube filler;
a quantity of biocides;
the paint base comprises volume solids and a volatile solvent;
the quantity of biocides and the volume solids being homogenously amalgamated into the volatile solvent; and
the tungsten sulfide nanotube filler being heterogeneously suspended throughout the paint base.

2. The antifouling paint formulation incorporating tungsten nanotubes, as claimed in claim 1, wherein the quantity of biocides is approximately 4.5% wt. of the paint formulation.

3. The antifouling paint formulation incorporating tungsten nanotubes, as claimed in claim 1, wherein the tungsten sulfide nanotube filler is approximately 6% wt. of the paint formulation.

4. The antifouling paint formulation incorporating tungsten nanotubes, as claimed in claim 1, wherein the volume solids are between 60% wt. and 64% wt. of the paint formulation.

5. The antifouling paint formulation incorporating tungsten nanotubes, as claimed in claim 4, wherein the volume solids are approximately 62% wt. of the paint formulation.

6. The antifouling paint formulation incorporating tungsten nanotubes, as claimed in claim 1, wherein the tungsten sulfide nanotube filler is a plurality of tungsten sulfide nanotubes.

7. The antifouling paint formulation incorporating tungsten nanotubes, as claimed in claim 6, wherein each of the plurality of tungsten sulfide nanotubes is configured as a cylindrical lattice structure.

8. The antifouling paint formulation incorporating tungsten nanotubes, as claimed in claim 6, wherein a fraction of the plurality of tungsten sulfide nanotubes is concentrically positioned within each other.

9. An antifouling paint formulation incorporating tungsten nanotubes comprises:
a paint base;
a tungsten sulfide nanotube filler;
a quantity of biocides;
the paint base comprises volume solids and a volatile solvent;
the quantity of biocides and the volume solids being homogenously amalgamated into the volatile solvent;
the tungsten sulfide nanotube filler being heterogeneously suspended throughout the paint base; and
the tungsten sulfide nanotube filler being a plurality of tungsten sulfide nanotubes.

10. The antifouling paint formulation incorporating tungsten nanotubes, as claimed in claim 9, wherein the quantity of biocides is approximately 4.5% wt. of the paint formulation.

11. The antifouling paint formulation incorporating tungsten nanotubes, as claimed in claim 9, wherein the tungsten sulfide nanotube filler is approximately 6% wt. of the paint formulation.

12. The antifouling paint formulation incorporating tungsten nanotubes, as claimed in claim 9, wherein the volume solids being is between 60% wt. and 64% wt. of the paint formulation.

13. The antifouling paint formulation incorporating tungsten nanotubes, as claimed in claim 12, wherein the volume solids is approximately 62% wt. of the paint formulation.

14. The antifouling paint formulation incorporating tungsten nanotubes, as claimed in claim 9, wherein each of the plurality of tungsten sulfide nanotubes is configured as a cylindrical lattice structure.

15. The antifouling paint formulation incorporating tungsten nanotubes, as claimed in claim 9, wherein a fraction of the plurality of tungsten sulfide nanotubes is concentrically positioned within each other.

16. An antifouling paint formulation incorporating tungsten nanotubes comprises:
a paint base;
a tungsten sulfide nanotube filler;
a quantity of biocides;
the paint base comprises volume solids and a volatile solvent;
the quantity of biocides and the volume solids being homogenously amalgamated into the volatile solvent;
the tungsten sulfide nanotube filler being heterogeneously suspended throughout the paint base;
the tungsten sulfide nanotube filler being a plurality of tungsten sulfide nanotubes;
the quantity of biocides is approximately 4.5% wt. of the paint formulation;
the tungsten sulfide nanotube filler is approximately 6% wt. of the paint formulation; and
the volume solids being is between 60% wt. and 64% wt. of the paint formulation.

17. The antifouling paint formulation incorporating tungsten nanotubes, as claimed in claim 17, wherein the volume solids is approximately 62% wt. of the paint formulation.

18. The antifouling paint formulation incorporating tungsten nanotubes, as claimed in claim 16, wherein each of the plurality of tungsten sulfide nanotubes is configured as a cylindrical lattice structure.

19. The antifouling paint formulation incorporating tungsten nanotubes, as claimed in claim 16, wherein a fraction of the plurality of tungsten sulfide nanotubes is concentrically positioned within each other.
